(19) United States
(12) Patent Application Publication
(10) Pub. No.: US 2011/0067543 A1
(43) Pub. Date: Mar. 24, 2011

(54) Direction of cut indicator

(76) Inventors: Donald Fisk Ames, Niantic, CT (US); Lawrence James Kuivanen, North Stonington, CT (US)

(21) Appl. No.: 12/807,942

(22) Filed: Sep. 16, 2010

Related U.S. Application Data
(60) Provisional application No. 61/276,931, filed on Sep. 18, 2009.

(51) Int. Cl. B26D 7/00

(52) U.S. Cl. 83/520

(57) ABSTRACT

The Direction of Cut Indicator is intended to be used by groundskeepers mowing the turf. It displays the direction the turf is to be cut on the day it is being cut.

This application claims priority to the Provisional Application #61/276,931 filed on Sep. 18, 2009 which is included by reference.

### BACKGROUND

The disclosure is directed towards a device utilized by individuals that mow turf, more particularly, the disclosure is directed towards a device that directs a user to mow the turf in a particular pattern.

All golf courses utilize mowing procedures that alternate (or change) the mowing patterns in a regular schedule. The reason for alternating the mowing pattern is not for purely aesthetic reasons. The mowing of the turf (or grass) causes the turf to lie over (or lean) in a particular direction. When you continually cut the turf in the same pattern, the turf will grow in a horizontal fashion so that the turf is of poor quality. By changing the direction of the cut, the turf is then encouraged to grow vertically.

Not only have golf courses relied on the alternating of patterns to encourage the vertical growth of grass for a smooth playing surface, other athletic fields, such as baseball, soccer, and football fields, and even homeowners, utilize alternating patterns to acquire a healthy turf. These patterns aid in the reduction of compaction by the mowers and encourage a more uniform removal of grasses.

In order to achieve a healthy turf using alternating patterns, the maintenance staff of a golf course or athletic field has to remember to change the pattern each time the turf is cut. Some golf courses or athletic fields employ a maintenance manager that establishes a schedule in which several individuals (i.e., staff) are utilized to cut the turf. In order to achieve a healthy turf with an aesthetically pleasing look, the maintenance manager must communicate with each employee about the proper direction for that particular day. The problem arises when there is a lack of communication between the maintenance manager and the employees about the proper direction for the mowing of the turf on a particular day.

What is needed in the art is a direction of cut indicator that can be coupled to a turf mowing device, which indicates the proper direction of mowing for a particular day.

### SUMMARY

The following presents a simplified summary of the present disclosure in order to provide a basic understanding of some aspects of the present disclosure. This summary is not an extensive overview of the present disclosure. It is not intended to identify key or critical elements of the present disclosure or to delineate the scope of the present disclosure. Its sole purpose is to present some concepts of the present disclosure in a simplified form as a prelude to the more detailed description that is presented herein.

The disclosure is directed toward a direction of cut indicator for illustrating the direction of cut for turf. The indicator comprises a body having a front opposite a rear, a first side opposite a second side, and an interior housing sufficient electronics for proper operation of the indicator. At least one display is coupled to the front of the body and the display is configured to project desired information. An attachment mechanism is coupled to the rear of the body and the attachment mechanism is configured to attach to a mower. A power switch is coupled to the body and the power switch is configured to turn the indicator on and off.

The indicator also comprises a direction of cut button, a date button, a time button, and a set button. Each button is coupled to the body and is configured to be utilized in programming the indicator. The at least one display can be partitioned into a first display area and a second display area. In the alternative, another display can be coupled to the front of the body to project desired information.

The indicator also comprises a direction of clean-up pass icon viewable in the display, in which the icon is configured to flash during setting procedures and is configured to change; a direction of cut icon viewable in the display, in which the icon is configured to flash during setting procedures and is configured to reflect a desired direction of cut; a date icon viewable in the display, in which the icon is configured to flash during setting procedures and is configured to change date as programmed; a time icon viewable in the display, in which the icon is configured to flash during setting procedures and is configured to change time as programmed; and a temperature icon viewable in the display, in which the icon is configured to change temperature as sensed by the direction of cut indicator.

The disclosure is also directed toward a direction of cut indicator for illustrating the direction of cut for turf. The indicator comprises a body having a front opposite a rear, a first side opposite a second side, and an interior housing sufficient electronics for proper operation of the indicator. At least one display is coupled to the front of the body and the display is configured to project desired information. An attachment mechanism is coupled to the rear of the body and the attachment mechanism is configured to attach to a mower. A power switch is coupled to the body and the power switch is configured to turn the indicator on and off. A remote transceiver is coupled wirelessly to the indicator and is configured to transmit and receive the desired information from the indicator.

The indicator provides that the remote transceiver is a dedicated transceiver or can be accessible over an interne connection. The indicator can be configured to act as a transceiver to transmit and receive the desired information.

### BRIEF DESCRIPTION OF THE FIGURES

Referring now to the figures, wherein like elements are numbered alike:

FIG. 1 is a front view of a an exemplary embodiment of the direction of cut indicator device coupled to a conventional mowing piece of equipment;

FIG. 2 is a front view of an exemplary embodiment of the direction of cut indicator device;

FIG. 3 is a side view of the exemplary embodiment of the direction of cut indicator device;

FIG. 4 is a rear view of the direction of cut indicator device;

FIG. 5 is a perspective view of an exemplary system utilizing at least one transceiver indicator device;

FIG. 6 is a perspective view of another exemplary system utilizing at least one transceiver indicator device;

FIG. 7 is a perspective view of a pattern illustrating a straight cut;

FIG. 8 is a perspective view of a pattern illustrating a left to right cut;

FIG. 9 is a perspective view of a pattern illustrating a cross cut;

FIG. 10 is a perspective view of a pattern illustrating a right to left cut;

FIG. 11 is a perspective view of a pattern illustrating a checkerboard cut;

FIG. 12 is a perspective view of a pattern illustrating a fifty-fifty cut; and

FIG. 13 is a perspective view of a pattern illustrating a diamond cut.

### DETAILED DESCRIPTION

Persons of ordinary skill in the art will realize that the following disclosure is illustrative only and not in any way limiting. Other embodiments of the disclosure will readily suggest themselves to such skilled persons having the benefit of this disclosure.

The present disclosure is directed to a device that provides a continuous, reliable, and accessible source of information for the efficient execution of a schedule for mowing turf. A turf mowing schedule generally itemizes the direction of the cut for the turf for a particular day. Generally, a maintenance manager communicates to each individual staff mowing for that day which direction to cut the turf. As can be expected, communication of the schedule to each staff member can be difficult and tedious for the maintenance manger. The device of the present disclosure solves this communication problem. The device can be automatically programmed to indicate the proper direction or be manually programmed from a remote device to provide the required information.

In one embodiment, the device is a direction of cut indicator and comprises a display, such as an LCD screen to display the direction of cut and other useful information and a series of operational buttons for programming the device. In another embodiment, the device is a direction of cut indicator that acts as a receiver of information. The device comprises a display, such as an LCD screen to display the direction of cut and other useful information. This embodiment can be remotely programmed by a host device.

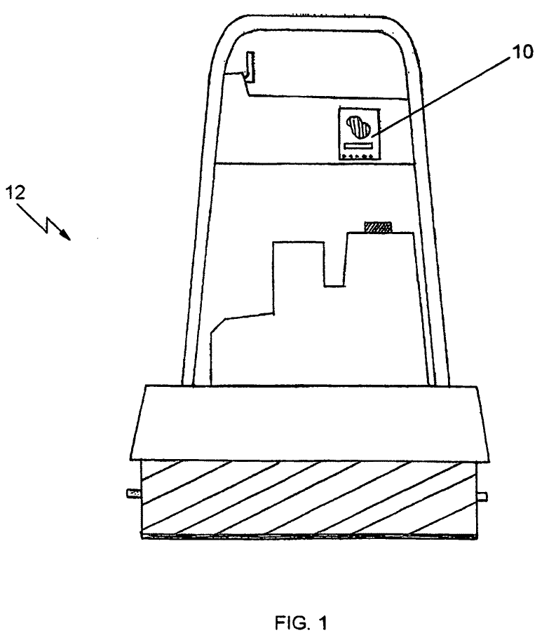

Referring now to FIG. 1, the direction of cut indicator (or indicator device) 10 is illustrated as being coupled to a console of a conventional mowing piece of equipment 12. Although a conventional walk behind mowing piece of equipment 12 is illustrated, it is contemplated that the indicator device 10 can be coupled to any piece of equipment 12 utilized to mow turf or lawn, including conventional riding or walk behind “mowers.” It is contemplated that multiple indicator devices 10 can be utilized for a team of equipment 12. It is also contemplated that only one indicator device 10 can be utilized (visible within a maintenance office or facility or other appropriate location) to indicate to several operators of equipment 12 the direction of cut for the day.

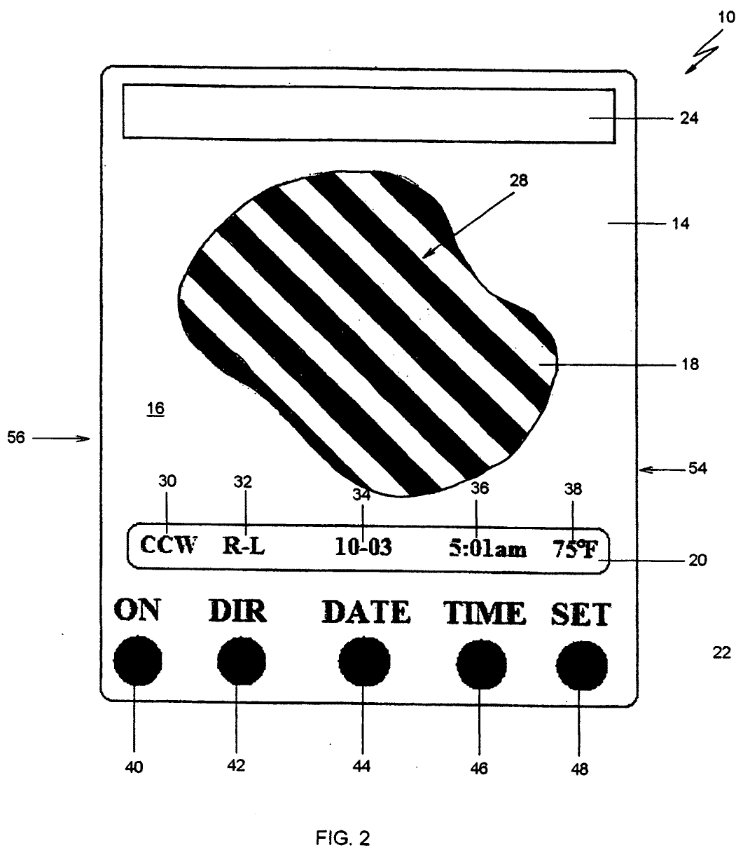

Referring now to FIG. 2, a front view of an exemplary embodiment of the indicator device 10 is illustrated. In a preferred embodiment, the indicator device 10 is a stand-alone device that operates continuously from its own power source. The indicator device 10 includes a body 14 having a front 16 with a first display (or screen) 18 and a second display (or screen) 20. A series of buttons (or touch pads or keys or switches) 22 for manual operation of the indicator device 10 is located on the front 16. It is also contemplated that an area 24 is located on the indicator device 10 for users to advertise specific places or companies, or to illustrate trademarks or logos.

The body 14 has a front 16 and a rear 26 with an interior (not shown) housing sufficient electronics (or electronic devices or electrical devices or electrical mechanisms) for the operation of the indicator device 10 as indicated herein.

The displays 18, 20 are utilized to provide information to a user. It is contemplated that the displays 18, 20 can be from one screen displaying the necessary information or two separate screens in which each screen displays desired information separately. Any conventional display screen 18, 20 is contemplated including liquid crystal display (LCD), plasma, and the like.

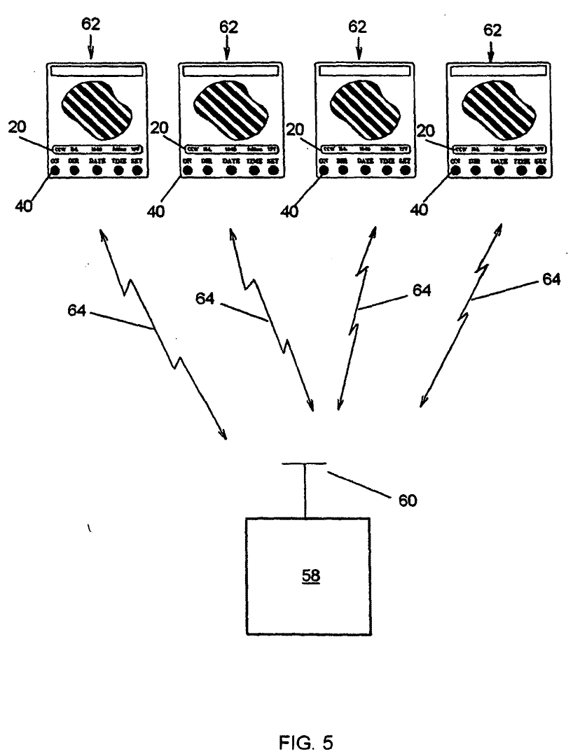

The first display 18 can be configured in any shape, as long as the first display 18 illustrates the desired direction of cutting the turf. The directions or patterns 28 utilized for cutting turf are generally standard in the industry and are further illustrated herein in FIGS. 7-13. These patterns 28 are programmed within the indicator device 10. The pattern 28 illustrated in the first display 18 in FIG. 2 is a right to left cut (R-L).

The second display 20 can be configured in any shape or series of shapes, as long as the second display 20 illustrates the desired information. In a preferred embodiment, the second display can illustrate (i.e., using icons, alphanumeric representations, or numerical representations) the direction of the clean-up pass 30, the direction of the pattern 32, the date 34, the time 36, and the outside temperature 38. The indicator device 10 is configured with appropriate devices to sense and display the outside temperature. The direction of the clean-up pass 30 can be either clockwise (CW) or counter-clockwise (CCW), CCW is illustrated.

The series of buttons 22 are utilized for the manual operation of the indicator device 10. Button ON (or power switch) 40 turns the device on and off. Button DIR 42 allows for setting the direction of the cut or pattern (e.g., R-L). Button DATE 44 is utilized for setting the date (e.g., 10-03). Button TIME 46 allows for the setting of the time (e.g., 5:01 am). Button SET 48 provides the means for setting all of the functions on the indicator device 10.

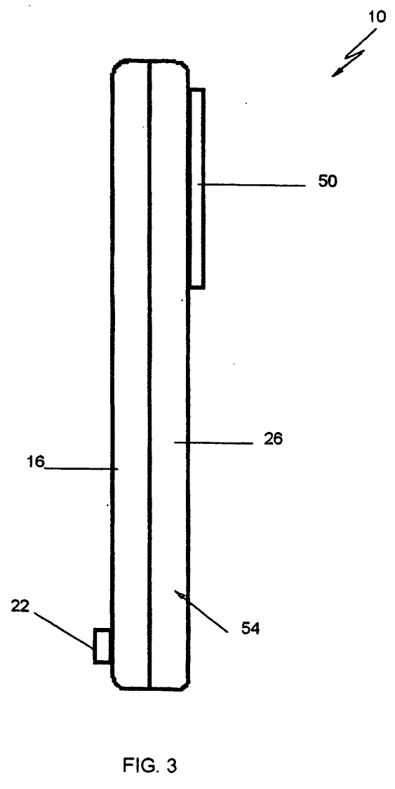

FIG. 3 illustrates a side view of the exemplary embodiment of the indicator device 10. The indicator device 10 has a front 16 and a rear 26. Coupled to the rear 26 is an attachment mechanism 50 for coupling the indicator device 10 to a piece of equipment 12. The attachment mechanism 50 can be any conventional attachment mechanism, including, but not limited to, magnet, hook and loop fastener, clip, snap, strap, mounting bracket, adhesive, and the like. It is contemplated that the attachment mechanism 50 be sufficient to securely fasten the indicator device 10 to a piece of equipment 12. In another embodiment, the indicator device 10 can be built into the console of the piece of equipment 12 by the manufacturer.

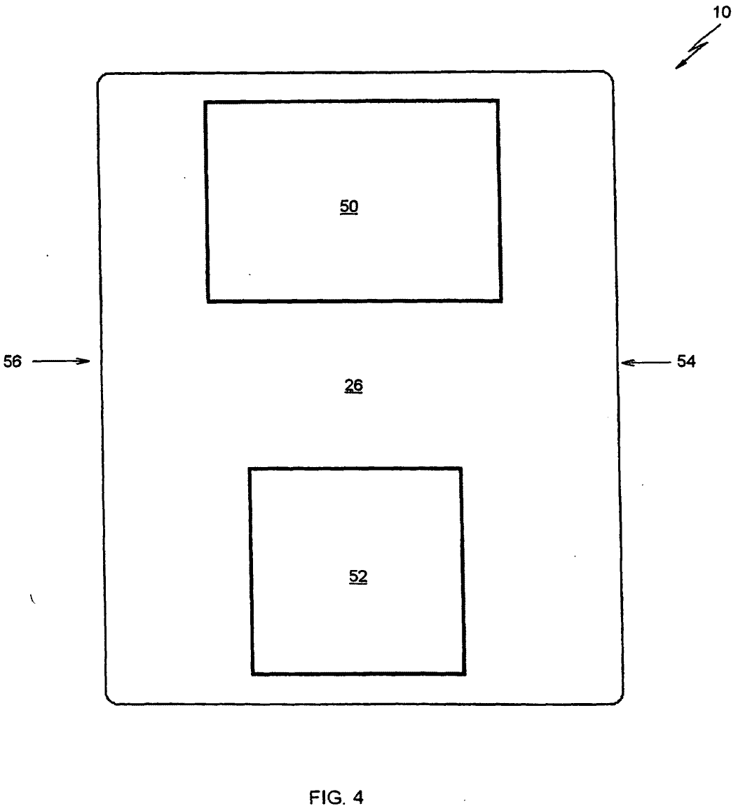

FIG. 4 illustrates a rear view of the indicator device 10. The rear 26 of the indicator device 10 can also have an access port 52 for opening the device to reach the interior (not shown). Although illustrated on the rear 26, it is contemplated that the access port 52 can be located at any convenient location of the indicator device 10, including the front 16 and sides 54, 56. The access port 52 can be utilized for accessing the power source, such as a battery (not shown). The access port 52 can be covered with a door (or panel) that can be easily removed by a sliding action, dislodging a clip, or unscrewing a screw. Other means of entry are also contemplated. It is also contemplated that the indicator device 10 may be solar powered.

The indicator device 10 is utilized to display the desired schedule for mowing of the turf. In one mode of operation, the desired pattern 28 is chosen for a particular date 34. At a specific time of day (i.e., midnight), the indicator device 10 automatically changes the desired pattern 28 (i.e., R-L) to a new desired pattern 28 (i.e., ST). The pattern 28 will change for each day; the number of patterns chosen depends upon the programming of the patterns in the indicator device 10 and the desired schedule of the user (e.g., maintenance manager). The indicator device 10 can operate on a continuous cycle changing every 24 hours or it can be programmed to change according to any desired schedule.

The indicator device 10 is durable, able to withstand the rigorous use of the piece of equipment 12. In particular, the indicator device 10 can be waterproof, shock resistant, and vibration resistant.

The indicator device 10 can be of any size, as long as it can be disposed on a piece of equipment 12. In a preferred embodiment, the indicator device 10 can be of a sufficient size to be held by an average adult hand. However, other embodiments can have small sized units depending upon the amount of information displayed and programmable buttons.

The indicator device 10 is easily operated, allowing a user to program the indicator device 10 as desired. In order to operate the indicator device 10, the user simply turns on the device by depressing the ON button 40. The display 18 will illustrate the direction of cut (or pattern) 26. The display 20 will illustrate the clockwise (CW) or counterclockwise (CCW) direction of the clean up pass 30, direction of cut 32, date 34, time 36, and temperature 38. The indicator device 10 is programmed to automatically detect the outside temperature 38 as indicated in display 20. This function can be particularly useful if there is a threat of freezing or the presence of frost. The indicator device 10 is programmed to automatically turn off thirty seconds after the last entry.

To choose the direction of cut, the user simply turns on the device by depressing the ON button 40. Next, the DIR button 42 is pushed. The display 18 will illustrate the current direction of cut (pattern) 26. The display 18 will be flashing. The user then pushes the DIR button 42 repeatedly until the desired pattern 28 is flashing. The user then pushes the SET button 48. To set each day, the user simply pushes the DIR button 42 repeatedly until the next day's desired pattern 28 is flashing. The user then pushes the SET button 48. The user continues with this procedure to set up a different pattern 28 for each consecutive day. The indicator device 10 will automatically update the display 20 in the information concerning the direction 32.

In order to set the date, the user simply turns on the device by depressing the ON button 40. Next, the user presses the DATE button 44. The display 20 will show the date 34. The month will be flashing. The user pushes the DATE button 44 repeatedly until desired month is flashing. The user then pushes the SET button 48. Next, the day of the month will begin to flash. The user pushes the DATE button 44 repeatedly until desired day is flashing. The user then pushes the SET button 48. The date will then be set.

In order to set the time, the user simply turns on the device by depressing the ON button 40. Next, the user presses the TIME button 46. The display 20 will show the time. The a.m. or p.m. hour will be flashing. The user pushes the TIME button 46 repeatedly until the desired a.m. or p.m. hour is flashing. Then the user pushes the SET button 48. Next, the minutes will be flashing. The user pushes the TIME button 46 repeatedly until the desired minutes are flashing. Lastly, the user pushes the SET button 48. The time will then be set.

In another embodiment, the direction of cut indicator device is not a stand-alone device and can be wirelessly coupled to a dedicated transceiver device (as illustrated in the system of FIG. 5) or wirelessly coupled to a remote system (as illustrated in the system of FIG. 6).

FIG. 5 illustrates a dedicated master transceiver 58 that has an antenna 60 allowing the master transceiver 58 to transmit and receive desired information (as illustrated with arrow 64) to at least one transceiver indicator device 62. The transceiver indicator device 62 is sufficiently similar to the indicator device 10 presented herein; however, the transceiver indicator device 62 is configured to transmit and receive desired information to the master transceiver 58. The transceiver indicator device 62 can have all programmable functions represented by buttons 42, 44, 46, and 48 removed (or made non-functional) and operate as a receiver and a transmitter of information related to the direction of mowing, time, date, temperature, and clean-up direction. In a preferred embodiment, each transceiver indicator device 62 can be turned on and off by button 40. The system illustrated in FIG. 5 is a dedicated system, allowing the user to program the transceiver indicator devices 62 from the master transceiver 58. The user can program the master transceiver 58 to transmit the desired information on a daily basis or the user can input a schedule to be transmitted daily to each transceiver indicator device 62.

In another embodiment illustrated in FIG. 6, the system comprises a master transceiver 66 that can transmit and receive information wirelessly over the interne to at least one transceiver indicator device 68 (as illustrated with arrow 70). The master transceiver 66 can be a computer, personal digital assistant, cellular phone, or similar device that can access a program stored in the master transceiver 66 or can access a program available over the internet via a website. The transceiver indicator device 68 is sufficiently similar to the indicator device 10 presented herein; however, the transceiver indicator device 68 is configured to transmit and receive desired information to the master transceiver 66. The transceiver indicator devices 68 can receive and transmit information related to the direction of mowing, time, date, temperature, and clean-up direction. The user can program the master transceiver 66 to transmit the desired information on a daily basis or the user can input a schedule to be transmitted daily to each transceiver indicator device 68.

Either of these two systems illustrated in FIGS. 5 and 6 allow one user to manage several indicator devices at the same time. This can be a great savings of time as well as an efficient means of communication.

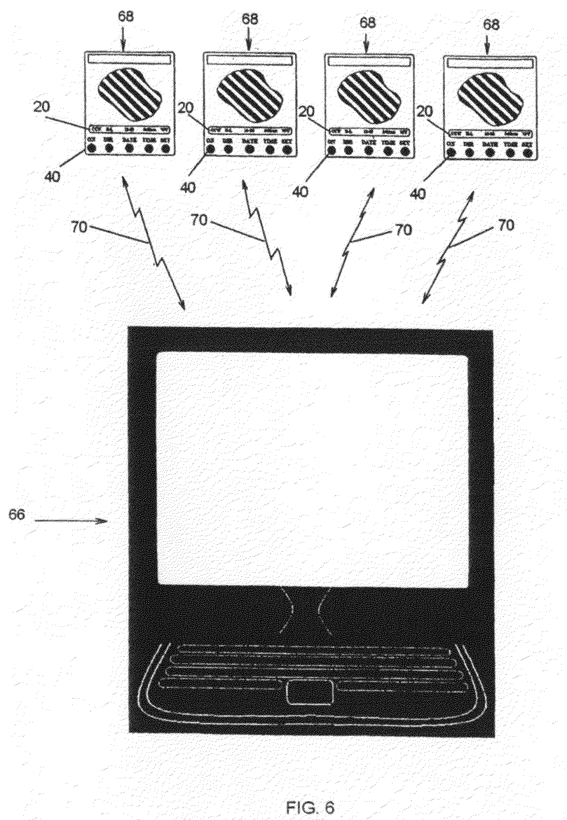

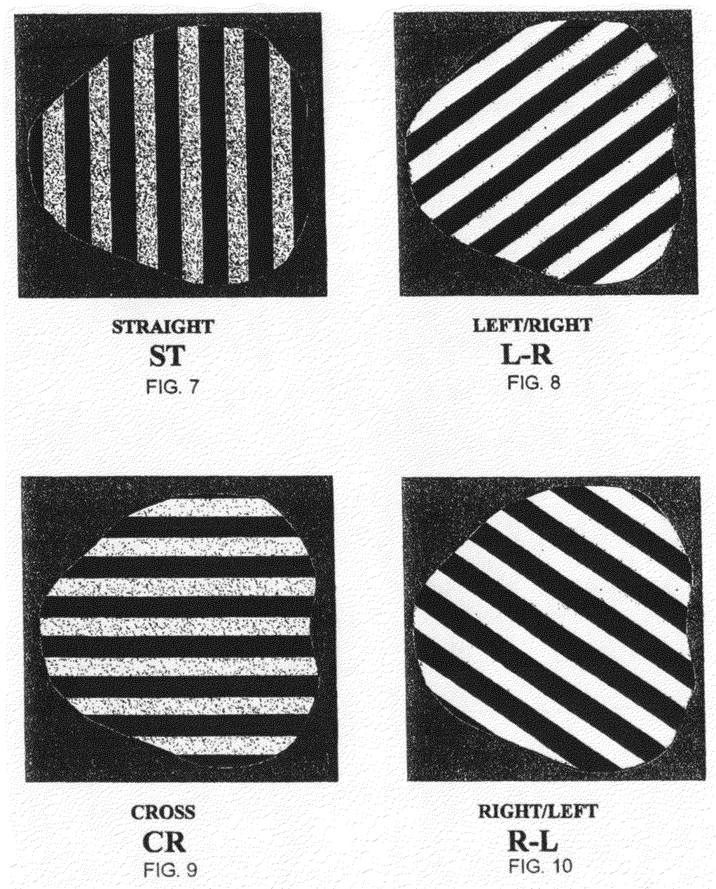

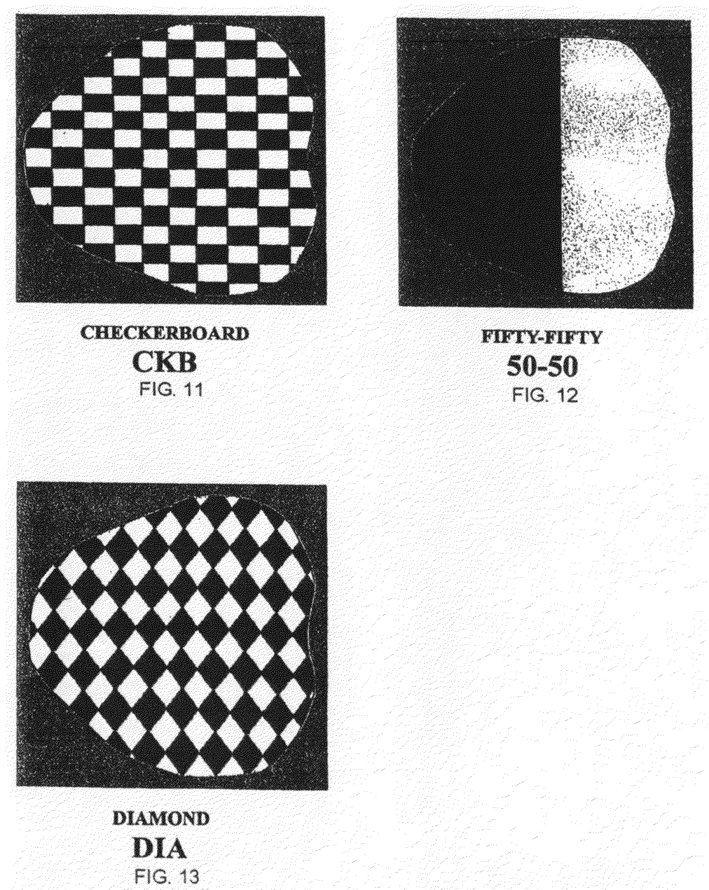

FIGS. 7-13 illustrate directions (or patterns) 28 utilized for cutting turf. FIG. 7 illustrates a straight cut. FIG. 8 illustrates a left to right cut. FIG. 9 illustrates a cross cut. FIG. 10 illustrates a right to left cut. FIG. 11 illustrates a checkerboard cut. FIG. 12 illustrates a fifty-fifty cut. FIG. 13 illustrates a diamond cut.

The advantages of the present invention are numerous. The direction of cut indicator is a continuous, reliable, and accessible source of information that will ensure correct and efficient execution of the schedule for direction of cut. The information concerning the direction of cut is accessible by all staff because the indicator is coupled to the mower. The device eliminates excess staff time used to double check the direction of cut as well as flawed guesswork, thus increasing staff efficiency. Additionally, the maintenance manager or other responsible person is relieved of the time consuming and tedious task of making sure the staff are aware of the desired direction of cut. The correct direction of cut is made possible without reliance on any personnel presence or communication.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings without departing from the essential scope thereof. Therefore, it is intended that the disclosure not be limited to the particular embodiment disclosed as the best mode contemplated for carrying out this disclosure.

1. A direction of cut indicator for illustrating the direction of cut for turf comprising:
a body having a front opposite a rear, a first side opposite a second side, and an interior housing sufficient electronics for proper operation of the direction of cut indicator;
at least one display coupled to said front of said body, said display configured to project desired information;
an attachment mechanism coupled to said rear of said body, said attachment mechanism configured to attach to a mower; and
a power switch coupled to said body, said power switch configured to turn the direction of cut indicator on and off.

2. The direction of cut indicator of claim 1, further comprising:
a direction of cut button coupled to said body, said direction of cut button configured to be utilized in programming the direction of cut indicator;
a date button coupled to said body, said date configured to be utilized in programming the direction of cut indicator;
a time button coupled to said body, said time button configured to be utilized in programming the direction of cut indicator; and
a set button coupled to said body, said set button configured to be utilized in programming the direction of cut indicator.

3. The direction of cut indicator of claim 1, wherein said at least one display is partitioned into a first display area and a second display area.

4. The direction of cut indicator of claim 1, further comprising:
another display coupled to said front of said body, said another display configured to project desired information.

5. The direction of cut indicator of claim 1, further comprising:
a direction of clean-up pass icon viewable in said display, said icon configured to flash during setting procedures and configured to change;
a direction of cut icon viewable in said display, said icon configured to flash during setting procedures and configured to reflect a desired direction of cut;
a date icon viewable in said display, said icon configured to flash during setting procedures and configured to change date as programmed;
a time icon viewable in said display, said icon configured to flash during setting procedures and configured to change time as programmed; and
a temperature icon viewable in said display, said icon configured to change temperature as sensed by the direction of cut indicator.

6. A direction of cut indicator for illustrating the direction of cut for turf comprising:
a body having a front opposite a rear, a first side opposite a second side, and an interior housing sufficient electronics to operate the direction of cut indicator;
at least one display coupled to said front of said body, said display configured to project desired information;
an attachment mechanism coupled to said rear of said body, said attachment mechanism configured to attach to a mower;
a power switch coupled to said body, said power switch configured to turn the direction of cut indicator on and off; and
a remote transceiver coupled wirelessly to the direction of cut indicator, said remote transceiver configured to transmit and receive said desired information from the direction of cut indicator.

7. The direction of cut indicator of claim 6, wherein said remote transceiver is a dedicated transceiver.

8. The direction of cut indicator of claim 6, wherein said remote transceiver is accessible over an interne connection.

9. The direction of cut indicator of claim 6, wherein the direction of cut indicator is configured to act as a transceiver to transmit and receive said desired information.
